(19) United States
(12) Patent Application Publication
(10) Pub. No.: US 2021/0034915 A1
(43) Pub. Date: Feb. 4, 2021

(54) METHOD AND APPARATUS FOR OBJECT RE-IDENTIFICATION

(71) Applicant: KOREA ADVANCED INSTITUTE OF SCIENCE AND TECHNOLOGY, Daejeon (KR)

(72) Inventors: Chan-Hyun YOUN, Daejeon (KR); Minsu JEON, Daejeon (KR); Seong Hwan KIM, Daejeon (KR)

(73) Assignee: KOREA ADVANCED INSTITUTE OF SCIENCE AND TECHNOLOGY, Daejeon (KR)

(21) Appl. No.: 16/943,182

(22) Filed: Jul. 30, 2020

(30) Foreign Application Priority Data
Jul. 31, 2019 (KR) 10-2019-0093300
Jul. 30, 2020 (KR) 10-2020-0095249

(51) Int. Cl. G06K 9/62; G06K 9/20; G06K 9/00

(52) U.S. Cl. CPC G06K 9/6215; G06K 9/6276; G06K 9/2054; G06K 9/00771; G06K 9/622; G06K 9/6289; G06K 9/629

(57) ABSTRACT

An object re-identification method performed by an object re-identification apparatus. The method includes detecting an object in a plurality of images; inferring object information including an attribute for the detected object; selecting an object having a same attribute as an identification target object from the inferred object information as a comparison target object; inferring a photographing angle of the selected comparison target object; selecting an identification candidate object from the comparison target object according to whether the inferred photographing angle is included in a predetermined angle range corresponding to the identification target object; and identifying whether the selected identification candidate object is matched with the identification target object.

### TECHNICAL FIELD

The present disclosure relates to an apparatus for re-identifying an object and a method of re-identifying the object.

### BACKGROUND

Smart city applications have appeared as a way to solve various problems in modern society, and among the smart city applications, a demand for a surveillance system occupies a large proportion. In order to provide a video surveillance service in the surveillance system, it is necessary to obtain information on each object in a collected video and to track a target object. To this end, re-identification of an object by matching and finding the target object in an image is required.

On the other hand, in terms of information sharing, crowdsourcing can receive data from multiple participants and share the received data. Therefore, the crowdsourcing can utilize a wide range of data in various situations.

When the crowdsourcing is applied to the surveillance system, data can be received from participants with mobility. Therefore, there is no limit to a range that can be analyzed without installing infrastructure such as surveillance cameras.

In addition, because various images captured at various viewpoints can be obtained, an object that is covered by another object at a specific photographing viewpoint can also be identified in an image reported from another participant.

However, when a crowdsourcing environment is used for the surveillance system, the object is required to be detected and re-identified from various images captured from various viewpoints.

### SUMMARY

According to an embodiment, an object re-identification method and an object re-identification apparatus capable of detecting and matching an object from various images captured at various viewpoints are provided.

In accordance with a first aspect of the present disclosure, there is provided an object re-identification method performed by an object re-identification apparatus. The method includes detecting an object in a plurality of images; inferring object information including an attribute for the detected object; selecting an object having a same attribute as an identification target object from the inferred object information as a comparison target object; inferring a photographing angle of the selected comparison target object; selecting an identification candidate object from the comparison target object according to whether the inferred photographing angle is included in a predetermined angle range corresponding to the identification target object; and identifying whether the selected identification candidate object is matched with the identification target object.

The problem to be solved in the present disclosure is not limited to those described above, and another problem to be solved that is not described may be clearly understood by those skilled in the art to which the present disclosure belongs from the following description.

According to an embodiment, the object may be detected and re-identified from the various images captured at the various viewpoints. For example, when the crowdsourcing is applied to a surveillance system to provide a video surveillance service, a photographing angle may be inferred, and then object re-identification may be performed based on the inferred photographing angle. Therefore, because it is possible to consider a spatiotemporal change according to mobility of participants that may occur in a crowdsourcing environment, there is an effect of improving re-identification performance of the object.

### BRIEF DESCRIPTION OF THE DRAWINGS

FIG. 1 shows a configuration of a surveillance system to which an object re-identification apparatus is applied according to an embodiment of the present disclosure.

FIG. 2 shows a block diagram of an object re-identification apparatus according to an embodiment of the present disclosure.

FIG. 3 shows a block diagram of a processor unit illustrated in FIG. 2.

FIG. 4 shows a flowchart illustrating an object re-identification method performed by an object re-identification apparatus according to an embodiment of the present disclosure.

FIG. 5 shows a flowchart illustrating an object re-identification method performed by an object re-identification apparatus according to an embodiment of the present disclosure.

FIG. 6 shows a flowchart illustrating an object re-identification method performed by an object re-identification apparatus according to an embodiment of the present disclosure.

### DETAILED DESCRIPTION

Advantages and features of the present disclosure, and a method of accomplishing the same will be clearly understood with reference to the embodiments described below together with the accompanying drawings. However, the present disclosure is not limited to the embodiments disclosed below, but may be implemented in many different forms. It is noted that the embodiments are provided to make a full disclosure and also to allow those skilled in the art to which the present disclosure belongs to know the full scope of the present disclosure, and the present disclosure are only defined by the scope of the claims.

The terms used in the detailed description will be described briefly, and the present disclosure will be described in detail.

The terms used in the detailed description have been selected from general terms that are currently widely used in consideration of functions in the present disclosure, but this may vary according to the intention of the technician working in the field, the precedent, the emergence of new technologies, or the like. In addition, in some cases, there are terms arbitrarily selected by the applicant, and in these cases, the meaning of the terms will be described in detail in a corresponding description paragraph. Therefore, the terms used herein should be defined based on the meaning of the terms and the overall contents of the present disclosure, not simple meanings of the terms.

Throughout the detailed description, when it is described that a part “includes” a certain component, it will be understood that other components may be further included rather than excluded unless explicitly described to the contrary.

In addition, the term ‘unit’ used in the detailed description refers to software or hardware components such as the FPGA or the ASIC, and the ‘unit’ performs some roles. However, the ‘unit’ is not limited to the software or the hardware. The ‘unit’ may be configured to be in an addressable storage medium, or to reproduce one or more processors. Therefore, as an example, the ‘unit’ includes components such as the software components, object-oriented software components, class components, and task components, processes, functions, properties, procedures, subroutines, segments of program code, drivers, firmware, microcode, circuitry, data, database, data structures, tables, arrays and variables. The components and functions provided in the ‘units’ may be combined into a smaller number of components and ‘units’, or may be further divided into additional components and ‘units’.

Hereinafter, embodiments of the present disclosure will be described in detail with reference to the accompanying drawings so that those skilled in the art to which the present disclosure belongs may easily implement the embodiments. In addition, in order to clearly describe the present disclosure, portions not related to the description are omitted in the drawings.

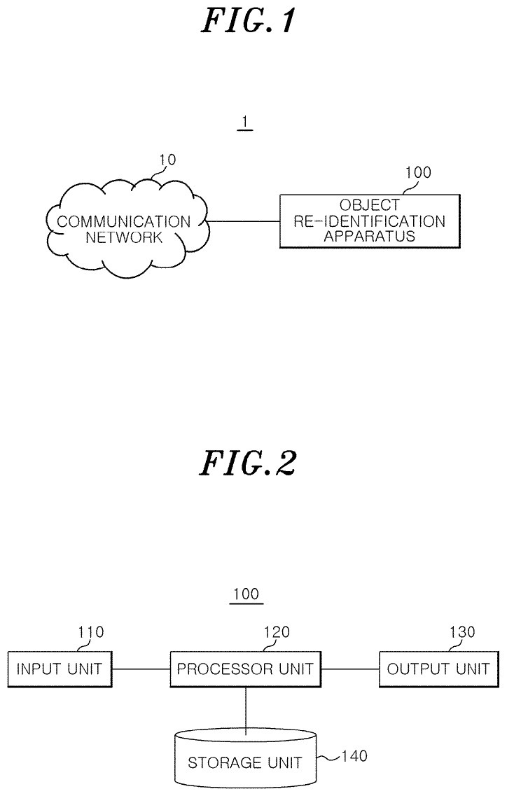

FIG. 1 shows a configuration of a surveillance system 1 to which an object re-identification apparatus 100 is applied according to an embodiment of the present disclosure.

Referring to FIG. 1, the surveillance system 1 may include the object re-identification apparatus 100, and the object re-identification apparatus 100 may be connected to a communication network 10 to operate in a crowdsourcing environment. For example, the object re-identification apparatus 100 may interwork with an edge server or a crowd server, or may be included in the edge server or the cloud server. In addition, an operation environment for the object re-identification apparatus 100 is not particularly limited, and may operate in various environments in which an image including a target object to be identified may be provided from a plurality of devices.

The object re-identification apparatus 100 may receive various images captured at various viewpoints through the communication network 10 and may detect and match an object included in the received images.

FIG. 2 shows a block diagram of the object re-identification apparatus 100 according to an embodiment of the present disclosure.

Referring to FIG. 2, the object re-identification apparatus 100 includes an input unit 110 and a processor unit 120. In addition, the object re-identification apparatus 100 may further include an output unit 130 and/or a storage unit 140.

The input unit 110 receives a plurality of images that may include an object that may be selected as an identification candidate object, and provides a plurality of the received images to the processor unit 120. For example, the input unit 110 may include a communication module capable of receiving image data through the communication network 10 of FIG. 1 or may include an interface capable of directly receiving the image data.

The processor unit 120 may process the images provided from the input unit 110 and may control the output unit 130 to output a result of the processing.

The processor unit 120 detects an object in a plurality of the images input through the input unit 110 and infers object information including an attribute for the detected object. Further, the processor unit 120 selects, from the inferred object information, an object having a same attribute as a target object to be identified (hereinafter, an identification target object) as a target object to be compared (hereinafter, a comparison target object), and infers a photographing angle of the selected comparison target object. Furthermore, the processor unit 120 selects the identification candidate object from among the comparison target objects according to whether the inferred photographing angle is included in a predetermined angle range corresponding to the identification target object. In addition, the processor unit 120 identifies whether the selected identification candidate object is matched with the identification target object.

Herein, the processor unit 120 may infer the photographing angle based on a result of comparing the selected comparison target object with reference shape information predetermined for each attribute of objects.

The processor unit 120 may use a deep learning model based on a convolutional neural network when inferring the object information or when selecting the comparison target object.

The processor unit 120 may add a fully connected layer to the last layer of the deep learning model based on the convolutional neural network when inferring the photographing angle, and then may input the inferred object information to the fully connected layer, thereby obtaining the photographing angle as an output of the fully connected layer.

When selecting the identification candidate object, the processor unit 120 may classify a region of interest (ROI) for an image of the comparison target object based on the predetermined angle range, and may select a plurality of the identification candidate objects based on a feature vector that may be expressed by using a feature value extracted from the classified ROI. Herein, the feature vector may be expressed by performing extraction of a pixel unit feature value and extraction of a convolutional-based feature value for the classified ROI, and then performing reconstruction a dimension fixing to a specific size. For example, the convolutional-based feature value may be extracted by using a matrix for outputting an intermediate convolution layer of the deep learning model based on the convolutional neural network.

When identifying whether a plurality of the selected identification candidate objects are matched with the identification target object, the processor unit 120 may perform clustering for a plurality of the selected identification candidate objects based on attributes, and may calculate an Euclidean distance between each clustered cluster and the identification target object to calculate a distance average, and may identify an identification candidate object in a cluster having the smallest calculated distance average as an object matched with the identification target object. Herein, the “attribute” may be a feature vector that may be expressed by using feature values extracted from the ROI.

The output unit 130 may output a result of the processing performed by the processor unit 120 under the control of the processor unit 120. For example, the output unit 130 may include a communication module capable of transmitting data as the result of the processing performed by the processor unit 120 or an interface capable of transmitting the data as the result of the processing to another electronic device. In addition, the output unit 130 may include a display device or a printing device capable of outputting the data as the result of the processing performed by the processor unit 120 to be visually identified.

The storage unit 140 may store the result of the processing performed by the processor unit 120 under the control of the processor unit 120. For example, the storage unit 140 may be a computer-readable storage medium such as a hardware device, specially configured to store and execute program instructions, that may be magnetic media including a hard disk, a floppy disk, and a magnetic tape, optical media including a CD-ROM and a DVD, magneto-optical media including a floptical disk, or a flash memory.

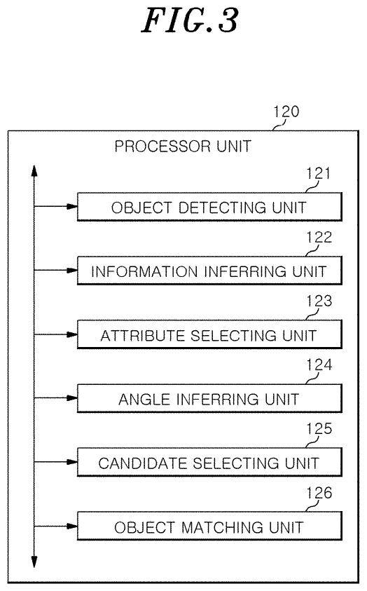

FIG. 3 shows a block diagram of the processor unit 120 illustrated in FIG. 2.

Referring to FIG. 3, the processor unit 120 may include an object detecting unit 121, an information inferring unit 122, an attribute selecting unit 123, an angle inferring unit 124, a candidate selecting unit 125, and an object matching unit 126.

The object detecting unit 121 detects an object in a plurality of input images.

The information inferring unit 122 infers object information including an attribute for the object detected by the object detecting unit 121.

The attribute selecting unit 123 selects an object having a same attribute as an identification target object from the object information inferred by the information inferring unit 122 as a comparison target object.

The angle inferring unit 124 infers a photographing angle of the comparison target object selected by the attribute selecting unit 123.

The candidate selecting unit 125 selects an identification candidate object from among the comparison target objects according to whether the photographing angle inferred by the angle inferring unit 124 is included in a predetermined angle range corresponding to the identification target object.

The object matching unit 126 identifies whether the identification candidate object selected by the candidate selecting unit 125 is matched with the identification target object.

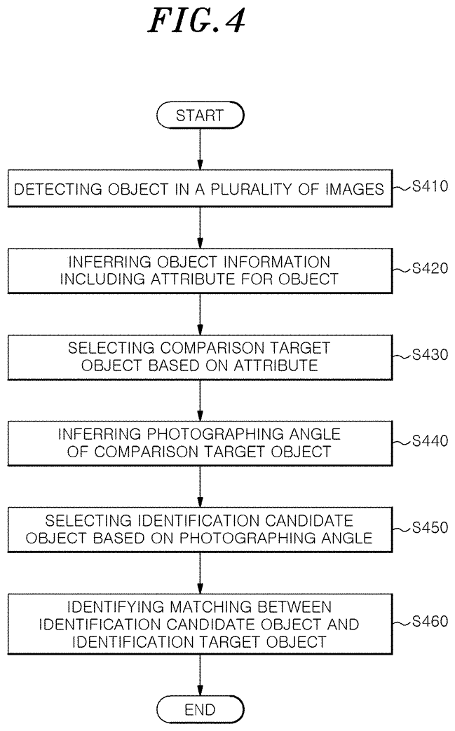

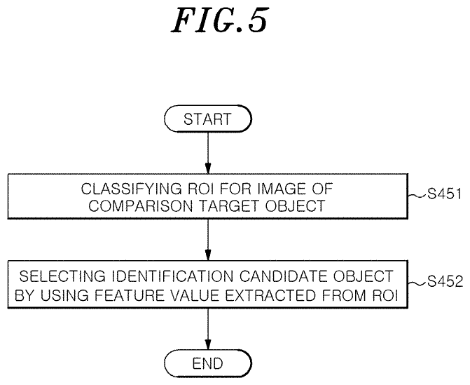

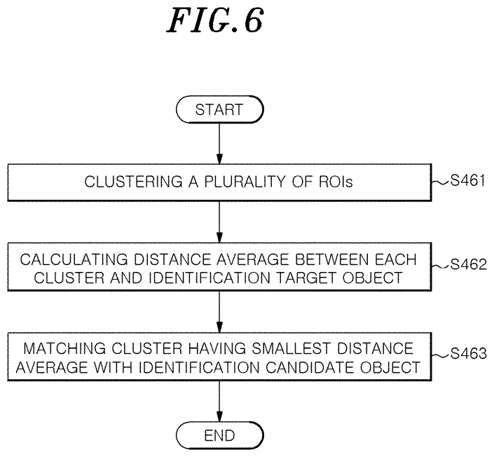

FIGS. 4 to 6 show flowcharts illustrating an object re-identification method performed by the object re-identification apparatus 100 according to an embodiment of the present disclosure.

Hereinafter, the object re-identification method performed by the object re-identification apparatus 100 in the surveillance system 1 according to an embodiment of the present disclosure will be described in detail with reference to FIGS. 1 to 6.

First, the input unit 110 of the object re-identification apparatus 100 obtains, through the communication network 10, a plurality of images that may include an object that may be selected as an identification candidate object, and provides the images to the processor unit 120. For example, crowdsourcing participants may photograph various images at various viewpoints by using a communication device equipped with a camera such as a smartphone, and the like, and may upload the various images photographed at the various viewpoints in the object re-identification apparatus 100 through the communication network 10.

Then, in a step S410, the object detecting unit 121 of the processor unit 120 detects an object in a plurality of the images input through the input unit 110, and, in a step S420, the information inferring unit 122 of the processor unit 120 infers object information including an attribute for the object detected by the object detecting unit 121.

Herein, when inferring the object information, the information inferring unit 122 may use a deep learning model based on a convolutional neural network. For example, a plurality of image data input through the input unit 110 may be input to a pre-trained deep learning model, and the pre-trained deep learning model may infer and output object information such as an attribute c of each object, center coordinates (cx, cy) of a boundary area, a width w and a height h of the boundary area, and the like which are detected from each image data. For example, the attribute c of the object may be information indicating whether the object is a car, a person, a thing, or the like.

Next, in a step S430, the attribute selecting unit 123 of the processor unit 120 selects an object having a same attribute as an identification target object from the object information inferred by the information inferring unit 122 as a comparison target object. In other words, the attribute selecting unit 123 may select the object having the same attribute as the identification target object from among the objects detected by the object detecting unit 121 as the comparison target object.

Next, in a step S440, the angle inferring unit 124 of the processor unit 120 infers a photographing angle of the comparison target object selected by the attribute selecting unit 123. Herein, the photographing angle may be inferred based on a result of comparing the selected comparison target object with reference shape information predetermined for each attribute of objects. The photographing angle may include an azimuth angle, an upward angle, a plane rotation angle, and the like, and the azimuth angle therein may be used as a representative value of the photographing angle. The azimuth angle is a coordinate representing a position of an object in a horizontal plane, the upward angle is an angle between a virtual line connecting the object and a photographing point and the horizontal plane, and the plane rotation angle is an rotational angle in a clockwise direction or a counterclockwise direction on the horizontal plane. For example, when inferring the photographing angle, the angle inferring unit 124 may add a fully connected layer into the last layer of the deep learning model based on the convolutional neural network, and then may input the object information inferred by the information inferring unit 122 into the fully connected layer to obtain the photographing angle as an output of the fully connected layer.

In addition, in a step S450, the candidate selecting unit 125 of the processor unit 120 selects the identification candidate object from among the comparison target objects according to whether the photographing angle inferred by the angle inferring unit 124 is included in a predetermined angle range corresponding to the identification target object.

When selecting the identification candidate object in the step S450, in a step S451, the candidate selecting unit 125 may classify, for an image of the comparison target object, a ROI based on the predetermined angle range. Further, in a step S452, the candidate selecting unit 125 may select the identification candidate object based on a feature vector that may be expressed by using a feature value extracted from the classified ROI. For example, the predetermined angle range for classification of the ROI may be defined to have four ROIs such as a front, a front side, a side, a rear side, a rear, and the like, and each angle range may be set according to characteristics of each object.

Herein, the feature vector may be expressed by performing extraction of a pixel unit feature value and a convolutional-based feature value for the classified ROI, and then performing reconstruction a dimension fixing to a specific size. For example, in order to extract the pixel unit feature value, a Scale Invariant Feature Transform (SIFT) technique may be applied. Further, a convolutional-based feature value may be extracted by using a matrix for outputting an intermediate convolution layer of the deep learning model based on the convolutional neural network. Herein, when extracting the pixel unit feature value by using the SIFT technique, since a dimensional size of an output feature value changes according to an input, the dimension may be fixed to the specific size. For example, by applying Vector of Locally Aggregated Descriptors (VLAD) pooling to the extracted pixel unit feature values, the dimension may be reconstructed into the specific size. Furthermore, in order to match the dimensional size between the pixel unit feature value and the convolutional-based feature value, the dimension of the pixel unit feature value may be reduced through Principal Component Analysis (PCA). Thereafter, the feature vector may be finally obtained by combining the pixel unit feature value and the convolutional-based feature value.

Next, in a step S460, the object matching unit 126 of the processor unit 120 identifies whether the identification candidate object selected by the candidate selecting unit 125 is matched with the identification target object.

When identifying whether the selected identification candidate object is matched with the identification target object in the step S460, in a step S461, the object matching unit 126 may perform clustering for the selected identification candidate object based on an attribute. For example, the object matching unit 126 may perform K-means clustering for the selected identification candidate object.

Next, in a step S462, a distance average may be calculated by calculating an Euclidean distance between each clustered cluster and the identification target object, and, in a step S463, an identification candidate object in a cluster having the smallest calculated distance average may be identified as an object matched with the identification target object.

On the other hand, a result of the processing performed by the processor unit 120, that is, information on the identification candidate object identified to be matched with the identification target object is output by the output unit 130 under the control of the processor unit 120. For example, the output unit 130 may transmit data as the result of the processing performed by the processor unit 120 through a communication module or an interface to another electronic device. Alternatively, the output unit 130 may output the data as the result of the processing performed by the processor unit 120 to be visually identified through a display device or a printing device.

In addition, the storage unit 140 may store the result of processing performed by the processor unit 120 under the control of the processor unit 120.

Each step included in the object re-identification method according to the above-described embodiment may be implemented in a computer-readable storage medium that stores a computer program including instructions for performing these steps.

In addition, each step included in the object re-identification method according to the above-described embodiment may be implemented in a form of a computer program stored in a computer-readable storage medium programmed to include instructions for performing these steps.

As described above, according to the embodiments of the present disclosure, an object may be detected and re-identified from various images captured at various viewpoints. For example, when a video surveillance service is provided by applying crowdsourcing to a surveillance system, a photographing angle may be inferred and then object identification may be performed based on the inferred photographing angle. Therefore, since it is possible to consider a spatiotemporal change according to mobility of participants that may occur in a crowdsourcing environment, there is an effect of improving identification performance of the object.

1. An object re-identification method performed by an object re-identification apparatus, the method comprising:
detecting an object in a plurality of images;
inferring object information including an attribute for the detected object;
selecting an object having a same attribute as an identification target object from the inferred object information as a comparison target object;
inferring a photographing angle of the selected comparison target object;
selecting an identification candidate object from the comparison target object according to whether the inferred photographing angle is included in a predetermined angle range corresponding to the identification target object; and
identifying whether the selected identification candidate object is matched with the identification target object.

2. The method of claim 1, wherein the photographing angle is inferred based on a result of comparing reference shape information predetermined for an attribute of an object and the selected comparison target object.

3. The method of claim 1, further comprising:
obtaining the plurality of the images through crowdsourcing.

4. The method of claim 3, wherein the inferring of the photographing angle includes:
adding a fully connected layer to a last layer of a deep learn model based on a convolutional neural network and obtaining the photographing angle as an output of the fully connected layer by inputting the inferred object information into the fully connected layer.

5. The method of claim 1, wherein the selecting of the identification candidate object includes:
classifying a region of interest (ROI) based on the predetermined angle range for an image of the comparison target object; and
selecting the identification candidate object based on a feature vector expressed by using a feature value extracted from the classified ROI.

6. The method of claim 5, wherein the feature vector is expressed by extracting a pixel unit feature value and a convolutional-based feature value for the classified ROI and performing reconstruction fixing to a dimension of a specific size.

7. The method of claim 6, wherein the convolutional-based feature value is extracted by using a matrix for outputting an intermediate convolution layer of a deep learning model based on a convolutional neural network.

8. The method of claim 1, wherein the identifying of whether the selected identification candidate object is matched includes:
performing clustering for the selected identification candidate object based on an attribute;
calculating a distance average by calculating an Euclidean distance between each clustered cluster and the identification target object; and
identifying an identification candidate object in a cluster having a smallest calculated distance average as an object matched with the identification target object.

9. An object re-identification apparatus comprising:
an input unit configured to receive a plurality of images;
a processor unit configured to perform processing for the images; and
an output unit configured to output a result of the processing performed by the processor unit,
wherein the processor unit is further configured to:
detect an object in the plurality of the images received by the input unit;
infer object information including an attribute for the detected object;
select an object having a same attribute as an identification target object from the inferred object information as a comparison target object;
infer a photographing angle of the selected comparison target object;
select an identification candidate object from the comparison target object according to whether the inferred photographing angle is included in a predetermined angle range corresponding to the identification target object; and
identify whether the selected identification candidate object is matched with the identification target object.

10. The apparatus of claim 9, wherein the photographing angle is inferred based on a result of a comparison of reference shape information predetermined for an attribute of an object and the selected comparison target object.

11. The apparatus of claim 9, wherein the input unit is configured to obtain the plurality of the images through crowdsourcing.

12. The apparatus of claim 9, wherein the processor unit is configured to, when inferring the photographing angle,
add a fully connected layer to a last layer of a deep learn model based on a convolutional neural network and obtain the photographing angle as an output of the fully connected layer by inputting the inferred object information into the fully connected layer.

13. The apparatus of claim 12, wherein the processor unit is configured to, when selecting the identification candidate object:
classify a ROI based on the predetermined angle range for an image of the comparison target object; and
select the identification candidate object based on a feature vector expressed by using a feature value extracted from the classified ROI.

14. The apparatus of claim 13, wherein the feature vector is expressed by extracting a pixel unit feature value and a convolutional-based feature value for the classified ROI and performing reconstruction fixing to a dimension of a specific size.

15. The apparatus of claim 14, wherein the convolutional-based feature value is extracted by using a matrix for outputting an intermediate convolution layer of the deep learning model based on the convolutional neural network.

16. The apparatus of claim 9, wherein the processor unit is configured to, when identifying whether the selected identification candidate object is matched:
perform clustering for the selected identification candidate object based on an attribute;
calculate a distance average by calculating an Euclidean distance between each clustered cluster and the identification target object; and
identify an identification candidate object in a cluster having a smallest calculated distance average as an object matched with the identification target object.

17. A non-transitory computer-readable storage medium including computer executable instructions, wherein the instructions, when executed by a processor, cause the processor to perform an object re-identification method, the method comprising:
detecting an object in a plurality of images;
inferring object information including an attribute for the detected object;
selecting an object having a same attribute as an identification target object from the inferred object information as a comparison target object;
inferring a photographing angle of the selected comparison target object;
selecting an identification candidate object from the comparison target object according to whether the inferred photographing angle is included in a predetermined angle range corresponding to the identification target object; and
identifying whether the selected identification candidate object is matched with the identification target object.
